(19) United States
(12) Patent Application Publication
(10) Pub. No.: US 2006/0028016 A1
(43) Pub. Date: Feb. 9, 2006

(54) Apparatus for the sealed fixing of a tube at the point where it enters a receptacle

(76) Inventors: René Chabidon, Saint Genis Laval (FR); Francois Vanney, Lyon (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/125,156

(22) Filed: May 10, 2005

(30) Foreign Application Priority Data
May 11, 2004 (FR) 0405081

(51) Int. Cl. F16L 35/00

(52) U.S. Cl. 285/2

(57) ABSTRACT

Apparatus (30) for the sealed fixing of a tube (1) at the point where it enters a receptacle is provided. One end (10, 11) of the tube (1) forming a ball joint (7, 8, 10, 11), cooperating with a component (7, 8) made of flexible material, is rigidly mounted in relation to the receptacle. The apparatus (30) has: a sleeve member (14), through which tube (1) passes and which is designed to be mounted integrally with the receptacle; and at least one O-ring (3, 4), against the tube, O-ring (3, 4) being housed in a groove in that part of the sleeve member (14) facing the tube (1).

### BACKGROUND OF THE INVENTION

The present invention relates to apparatus for the sealed fixing of a tube at the point where it enters a receptacle.

From EP-A-0 128 818 and U.S. Pat. No. 4,689,130 industrial processes are known using photochemical reactors.

From U.S. Pat. No. 3,998,477 apparatus is also known for fixing a tube on a pipe of a container, permitting sealed fixing of a quartz tube while allowing small movements of the tube.

When strong turbulence occurs in such a container or if the tube used is very long, the tube may break (for example with a quartz tube) or bend (for example with a steel tube). The stresses exerted on the tube often lead to permanent deformations of the lip seals ensuring the seal and of the O-rings at the top of the tube outside the reactor.

EP-A-0 321 341, in the name of the assignee, discloses apparatus for the sealed fixing of an essentially circular-section tube passing through the wall of a container, in which the end of the tube outside the container forms, in combination with a component made of flexible material, a ball joint and in which the seal of the tube that passes through the wall of the container is ensured by at least one lip seal. Such apparatus allows the sealed fixing of a tube that passes through the wall of a container and is able to withstand the substantial mechanical stresses caused by a turbulent liquid medium, and by the strain resulting from the internal pressure of the container on the section of the tube.

However, the above-mentioned tube-fixing devices have drawbacks. The seals used have poor chemical resistance. Using these seals in an aggressive chemical medium therefore requires frequent maintenance operations and even dangerous situations associated with leaks, thus resulting in expensive shut-downs in production.

### SUMMARY OF THE INVENTION

A need therefore exists for apparatus for fitting a tube to a receptacle which would reduce the frequency of maintenance operations.

To this end, the invention discloses apparatus for the sealed fixing of a tube at the point where it enters a receptacle, one end of the tube forming a ball joint cooperating with a component made of flexible material, rigidly mounted in relation to the receptacle, said apparatus having: a sleeve member, through which the tube passes and which is designed to be mounted integrally with the receptacle; and at least one O-ring, against the tube, the O-ring being housed in a groove in that part of the sleeve member facing the tube.

In preferred embodiments, the invention has one or more of the following characteristics:
the apparatus has two O-rings, against the tube, each of the O-rings being housed in a groove in that part of the sleeve member facing the tube;
the sleeve member is able to be partially inserted into the neck of a receptacle-access pipe;
at least one O-ring is made of a perfluorinated elastomer material;
the sleeve member also has a safety O-ring against the tube;
said end of the tube has a convex shape, in contact with the component made of flexible material; and
tube 1 has ultraviolet radiation emitters.

The invention also relates to a receptacle having apparatus according to the invention.

Other characteristics and advantages of the invention will become apparent when reading the following detailed description of embodiments of the invention, given by way of example only and with reference to the attached single FIG. 1.

### BRIEF DESCRIPTION OF THE DRAWINGS

FIG. 1 shows a longitudinal section of apparatus for the sealed fixing of a tube at the point where it enters a receptacle according to an embodiment of the invention.

### DETAILED DESCRIPTION OF PREFERRED EMBODIMENTS

The invention provides apparatus for the sealed fixing of a tube at the point where it enters a receptacle. One end of the tube forms a ball joint cooperating with a component made of flexible material designed to be rigidly mounted in relation to the receptacle. The apparatus has: a sleeve member, through which the tube passes and which is designed to be mounted integrally with the receptacle; and at least one O-ring, against the tube, the O-ring being housed in a groove in that part of the sleeve member facing the tube. Such an O-ring is durable, easy to manufacture and can be made of materials which are very chemically resistant such as perfluorinated elastomer materials. As a result apparatus according to the invention requires less maintenance than devices of the prior art. Moreover the apparatus according to the invention improves safety by reducing the risk of leakage.

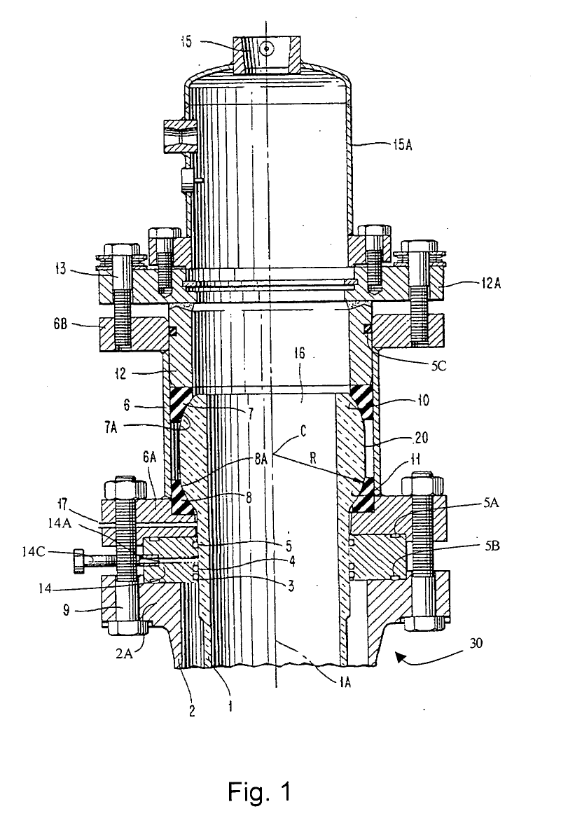

FIG. 1 represents a longitudinal section of apparatus for the sealed fixing of a tube at the point where it enters a receptacle according to an embodiment of the invention.

FIG. 1 shows in particular a tube 1, with a more or less circular section, at the point where it enters a receptacle.

This tube 1 can comprise any combination of materials, be made of just one material, if appropriate, and can be of any size. The tube can for example comprise glass, quartz, graphite, perfluorinated elastomer materials or polymer derivatives such as polytetrafluoroethylene, polypropylene, polyvinyl chloride or materials obtained from metals or alloys such as steel, plated steel, stainless steel, nickel, copper or monel. The tube can also be solid or hollow.

The tube is, if appropriate, mounted rotating around a point C which is fixed in relation to the receptacle. This fixed point C is, preferably, outside the receptacle, as in the embodiment shown in FIG. 1. This point C is also situated on the longitudinal axis 1A of tube 1. In this way, the apparatus 30 can have for example a swivel mechanism, comprising the combination of elements 7, 8, 10, 11 in the embodiment represented in FIG. 1 or only the combination of elements 8, 11 according to a variant. This mechanism allows tube 1 to swivel around point C, substantially at one end 10, 11 of the tube.

The receptacle, which is situated at the bottom of FIG. 1 in the embodiment illustrated, can for example have an access-pipe 2. A pipe 2 for example allows a calibrated access to the inside of the receptacle. Below pipe 2, a part of tube 1 penetrates the receptacle, while the end 10, 11 of the tube is, preferably, outside pipe 2.

The receptacle can be used for example as a chemical reactor or a distillation column. It can also contain a fluid under pressure or under vacuum. The swivel connection 7, 8, 10, 11 allows small movements of the tube, as is known from the prior art. It allows a small rotation of the tube in order to absorb vibrations such as those produced by turbulence caused, for example, by a fluid in the receptacle.

Apparatus 30 has a sleeve member 14. This sleeve member can be arranged substantially between point C and pipe 2, along the longitudinal axis 1A of tube 1. The sleeve member is integral with the receptacle via an intermediate component, if appropriate. It can be attached to the receptacle in different ways, one example of attachment will be described later. This sleeve member 14 has an aperture, which is for example circular, for the passage of tube 1 (for this purpose it can be in the form of a section of hollow cylinder or a gasket). Moreover, the sleeve member may have several parts (such as jaws) which can be attached. The sleeve member can for example advantageously be in the form of a concentric-clamping jaw chuck, i.e. a clamp chuck in which the jaws move simultaneously in relation to a component to be fixed while retaining a common center. The sleeve member can also advantageously for example be in the form of a combination chuck, i.e. a chuck whose jaws can be tightened simultaneously or separately. It can also be in the form of two half-sections of a cylinder which can be brought together in order to adjust the opening diameter to the external diameter of tube 1. The fact that the sleeve member has several parts makes it easy to dismantle and, if appropriate, replace an O-ring on the sleeve member. To make it easier to fit tube 1 into sleeve member 14, the opening diameter should be slightly bigger than the external diameter of the tube.

In one embodiment, the apparatus has an O-ring 3, 4. O-ring 3, 4 is placed against tube 1 and is housed in a groove in that part of sleeve member 14 facing tube 1.

This O-ring seals the apparatus vertically between sleeve member 14 and tube 1.

Preferably, the major part of the O-ring (for example 95%), seen here, by way of example, in section, is housed in the groove. The O-ring is then “streamlined”. Only a small part of the seal protrudes beyond the groove. The protection provided by the groove thus prevents, at least in part, damage (such as distortion and splitting) to the O-ring caused for example by the presence of fluids in the receptacle. However, the fact that the O-ring is housed in the groove does not necessarily prevent the O-ring from swelling. This can help to improve sealing because swelling of the seal increases the seal's pressure against the tube. By contrast, using seals which are not particularly symmetrical, such as lip seals, prevents the major part of such seals from being housed in a groove. Seals which are not particularly symmetrical and have not been streamlined, or at least not much, are therefore exposed and are particularly susceptible to the fluids contained in the receptacle. Such seals are subject to unrestricted swelling (as there is no groove). This swelling thus risks causing damage to the seal. Moreover, an O-ring is easier to manufacture and can be made of durable materials which have high chemical resistance, such as perfluorinated elastomer materials, and little waste. As a result, apparatus according to the invention requires less maintenance than devices of the prior art. Safety is also improved as compared to devices of the prior art, particularly as regards the risk of leakage. Moreover, less material is required to produce an O-ring

Preferably, the apparatus has two O-rings 3, 4 on the inner surface of the sleeve member 14, i.e. the surface facing tube 1. Each O-ring 3,4 is housed in a groove in sleeve member 14 facing tube 1. Part of the O-ring 3, 4 protrudes (slightly) beyond the groove in which it is housed and presses against tube 1. The mid planes associated with each of the O-rings 3, 4 or with each of the associated grooves are preferably substantially parallel and, moreover substantially perpendicular to the longitudinal axis 1A of the tube at rest. The distance between these mid planes could for example be chosen to be as small as possible so as not to obstruct the movements of the tube. In practice, the distance is typically in the order of a centimetre.

The two O-rings seal the apparatus vertically between sleeve member 14 and tube 1. Surprisingly enough, using two O-rings proved to create a much more reliable seal than using just one O-ring. In particular, between two O-ring replacement operations, the operating period (or service life) of the apparatus according to the invention using two O-rings is much longer than that obtained using just one. In fact, the service life using two O-rings is much more than twice that obtained using a single O-ring. The effectiveness of the seal obtained is therefore non-linear.

Apparatus according to the invention thus requires less maintenance (to replace one or more damaged O-rings, for instance) compared to devices of the prior art.

Moreover, since O-rings 3, 4 are housed in grooves, they are partially streamlined and, as a result, protected. They are therefore less exposed to the damage experienced by the lip seals conventionally used in devices used to fit a tube to a receptacle of the prior art. As a result, the resistance and consequently the lifetime of the O-rings are improved.

In one embodiment, access-pipe 2 has a pipe neck 2A, at the top of pipe 2, as represented in FIG. 1 (at the bottom of FIG. 1 to be precise). Sleeve member 14 is situated substantially between swivel mechanism 7, 8, 10, 11 and pipe neck 2A along the longitudinal axis 1A of the tube. Pipe 2 and, in particular, pipe neck 2A allow tube 1 to be connected to the receptacle.

Moreover, it is possible partially to insert sleeve member 14 into pipe neck 2A. Sealing between sleeve member 14 and pipe neck 2A can also be achieved by means of an O-ring 5B. This O-ring can, if appropriate, be housed in a more or less circular groove, facing pipe neck 2A.

Partially inserting sleeve member 14 in pipe neck 2A also improves both the fit of the sleeve member and the position and hold of the tube along axis 1A.

In one embodiment at least one of the O-rings 3, 4 (and, if necessary, O-rings 5A, 5B, 5C) is made of a perfluorinated elastomer material, i.e. an elastomer whose hydrogen atoms have been replaced by fluorine atoms.

This type of material produces particularly efficient seals. Now, because of their complex shapes, lip seals are unavailable in or impossible to produce from a perfluorinated elastomer material. By contrast, O-rings lend themselves particularly well to the use of this type of material and also require much less material by comparison.

Intone embodiment, O-rings 3, 4 are made of polytetrafluoroethylene (PTFE), which provides excellent resistance to chemical substances, good thermal stability and a low friction coefficient.

It is also possible to use another perfluorinated material, such as kalrez.

If necessary, the O-rings can be made using a perfluorinated elastomer combining the elastic properties of a fluorinated elastomer and the chemical and thermal resistance of PTFE, enabling continuous use up to temperatures exceeding 300° C.

The use of O-rings made of a fluorinated elastomer such as viton can also be foreseen.

In other embodiments, a combination of O-rings (such as 3, 4, 5, 5A, 5B, 5C, 7 and 8), made of the various above-mentioned materials, may be used to achieve the best possible quality-to-price ratio of all of the O-rings.

In one embodiment, sleeve member 14 also has a third O-ring 5, housed in a groove in the sleeve member and pressing against tube 1. This O-ring 5 is a safety O-ring, allowing a leak to be contained at least temporarily in the event of failure of O-rings 3, 4. The sleeve member also has an aperture 14A in that surface of sleeve member 14 facing tube 1, between O-ring 5 and O-rings 3, 4. The third O-ring 5 is therefore on the opposite side to the two O-rings 3, 4 in relation to the plane in which aperture 14A is found. This aperture 14A opens onto a channel which can be blocked by a screw 14C. This channel can be connected to a leak detector (such as a pressure alarm), in order to prevent any leaks due, for example, to a sealing failure of the two O-rings 3, 4.

Screw 14C can be a connection pipe as is known from the prior art.

The end 10,11 around which tube 1 swivels can also have a convex shape, like the embodiment represented in FIG. 1. This end is in contact with at least one seal 8, and preferably two seals 7, 8, made of flexible material with which the end 10, 11 forms a swivel mechanism 7, 8, 10, 11 (more particularly in this case a ball joint). The flexible material that can be used to make the seals includes standard materials such as natural or artificial rubbers, fluorinated and chlorofluorinated polymers, ethylene propylene copolymers, etc. This ball joint allows small rotations of the tube around the fixed point C, approximately in the center of the convex shape 10, 11, in order to absorb vibrations and allow tube 1 to be held in place counteracting the background effect on the section of the tube.

In one embodiment, tube 1 has ultraviolet radiation emitters (or UV lamps) to be used in a photochemical reactor, such as a free-radical chlorination reactor, operating under pressure if necessary. Its diameter is thus typically between 30 and 300 mm and its length between 1 and 6 m. The tube can be made of quartz or glass and be hollow to accommodate UV lamps and, if necessary, a cooling device.

In the embodiment represented in FIG. 1, component 6 is welded (or mechanically-welded) to plates (or flanges) 6A and 6B and attached to pipe 2 of the receptacle (via pipe neck 2A) by bolts 9. Elements 2A and 6A grip sleeve member 14 which, as a result, is attached to the receptacle. Spherical sectors 10 and 11 give the end of the tube its convex shape. The end has a cylindrical section 20 between the spherical sectors 10 and 11. The convex end of the tube can be inscribed in a sphere whose radius R extends from point C located substantially on the longitudinal axis 1A of the tube. The tube also has an aperture 16 to insert the UV emitters and, if necessary, their cooling device. Component 12, welded to plate 12A, allows seals 7 and 8 to be adjusted and squeezed together by means of bolts 13, which connect the plates (or flanges) 12A and 6B together. The power supply of the UV lamp which is in tube 1 is fed through aperture 15. For the sake of clarity, the system that plugs aperture 15 thus preventing the contents of the container from being emptied in the event of tube 1 breaking, is not represented in FIG. 1. Surfaces 7A and 8A of seals 7 and 8 respectively conform to spherical sectors 10, 11 of the end of tube 1. Seals 7 and 8 allow tube 1 to be held, while resisting the background effect caused by the pressure inside the container on the section of the tube, as described above. These seals 7 and 8 allow a small rotation of the tube around the centre C. This rotation is limited, in particular by O-rings 3 and 4. Although the rotation is limited (the maximum angle of deviation in relation to axis 1A is typically in the order of a fraction of a radian), it is sufficient to prevent breakages caused by turbulence of the liquid medium inside the container. Plate 6A has a channel 17 issuing into an aperture facing tube 1, allowing additional leak detection, downstream of O-ring 5.

The invention is, however, not limited to the variants described above but includes many other variations which are readily available to a person skilled in the art. For example, the invention includes a receptacle and by extension any receptacle having apparatus according to the invention.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding French application No. 04 05 081, filed May 11, 2004 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Apparatus for the sealed fixing of a tube at the point where it enters a receptacle, one end of the tube forming a ball joint cooperating with a component made of flexible material, rigidly mounted in relation to the receptacle, said apparatus having:
a sleeve member through which tube passes and which is designed to be mounted integrally with the receptacle; and
at least one O-ring, against the tube, the O-ring being housed in a groove in that part of said sleeve member facing said tube.

2. The apparatus according to claim 1, wherein said apparatus has two O-rings, against the tube, each of the O-rings being housed in a groove in that part of the sleeve member facing the tube.

3. The apparatus according to claim 2, wherein said sleeve member is able to be partially inserted into the neck of a receptacle-access pipe.

4. The apparatus according to claim 1, wherein at least one of the said O-rings is made of a perfluorinated elastomer material.

5. The apparatus according to claim 1, wherein said sleeve member also has a safety O-ring against the tube.

6. The apparatus according to claim 1, wherein said end of the tube has a convex shape, in contact with a component made of flexible material.

7. The apparatus according to claim 1, wherein the tube has ultraviolet radiation emitters.

8. A receptacle having apparatus for the sealed fixing of a tube at the point where it enters the receptacle, one end of the tube forming a ball joint cooperating with a component made of flexible material, rigidly mounted in relation to the receptacle, and said apparatus having: a sleeve member through which tube passes and which is designed to be mounted integrally with the receptacle; and at least one O-ring, against the tube, the O-ring being housed in a groove in that part of said sleeve member facing tube.
